(19) United States
(12) Patent Application Publication
(10) Pub. No.: US 2024/0380243 A1
(43) Pub. Date: Nov. 14, 2024

(54) LIGHTWEIGHT WIRELESS CHARGING DEVICE WITH A RETRACTABLE CABLE

(71) Applicant: Yi CHEN, GUANGDONG (CN)

(72) Inventor: Yi CHEN, GUANGDONG (CN)

(21) Appl. No.: 18/237,909

(22) Filed: Aug. 25, 2023

(30) Foreign Application Priority Data
May 8, 2023 (CN) 202321093928X
May 24, 2023 (CN) 2023212781088
Jul. 28, 2023 (CN) 2023109465198

(51) Int. Cl. H02J 50/00; H02G 11/02

(52) U.S. Cl. CPC H02J 50/005; H02G 11/02

(57) ABSTRACT

The present invention discloses a lightweight wireless charging device with a retractable cable, comprising a housing assembly, a wireless charging module, a retractable cable and a rotating subassembly; the rotating subassembly comprises a wheel core and a clockwork spring, the wireless charging module is directly installed on the wheel core and does not come into contact with the housing assembly; the retractable cable passes through the wheel core and is electrically connected with the wireless charging module. Such design eliminates the need to install a wireless charging module on the housing assembly and allows the wireless charging module to be embedded in the housing assembly, and thus reduces the overall thickness of the product.

### BACKGROUND OF THE INVENTION

The present invention relates to the technical field of charging devices, in particular relates to a wireless charging device with a retractable cable.

The wireless charging mode has become popular with a plurality of users due to its convenience; in order to further improve the convenience of the wireless charging mode, some people have combined a retractable data cable with the wireless charging mode to realize a wireless charging device with a retractable cable. However, at present, the wireless charging devices with retractable data cables on the market have generally had the following technical problems: firstly, the wireless charging modules are installed on the housing assemblies, and thus it is necessary to arrange a dedicated stationary structure on the housing assemblies to install the wireless charging modules, e.g. a watch wireless charger with a retractable cable disclosed by Patent CN201922160117.7; such structural design has significantly increased the overall thickness of this type of products, and the increase goes against the trend of being light and thin and further will cause the problem of being inconvenient to carry this type of products; secondly the wireless charging module installed on the housing assembly does not rotate with the wheel core; therefore, it is necessary to arrange an adapter plate, a connector or other necessary connecting elements with sliding rings to achieve electrical connection of the wireless charging module with the retractable data cable, causing a more complicated structure and higher cost; moreover, the contact connection of electrical connection causes poor stability and short service life; thirdly, the clockwork spring cavity is arranged in the housing assembly, concretely between the bottom housing and the wheel core, one end of a clockwork spring is connected with the mounting shaft in the center of the bottom housing and the other end is connected with a rotating element, the wheel core is installed on the rotating element and utilizes the potential energy of the clockwork spring to drive the rotating element to rotate and thus drive the wheel core to rotate, e.g. a retractable double-pull data cable device disclosed by Patent CN202221501859.7. Such structural design causes a stacked structure between the wheel core and the clockwork spring, further increasing the overall thickness of product. Furthermore, in order to locate the extended data cable, the existing wireless charging device with a retractable data cable is usually arranged with a steel ball locating structure or a track plate with a track groove to couple the locating element; however, the steel ball locating structure will complicate the overall structure and cause poor locating effect, and that the combination of the track plate with the locating element will increase the overall thickness of product.

### BRIEF SUMMARY OF THE INVENTION

The technical problem to be solved by the present invention is to provide a lightweight wireless charging device with a retractable cable which is characterized by a simpler structure, more reasonable design, smaller overall product thickness, lighter weight, more stable electrical connection of the wireless charging module and a longer service life.

To solve the above technical problems, the present invention adopts the following technical solution: a lightweight wireless charging device with a retractable cable, comprising a housing assembly, a wireless charging module, a retractable cable and a rotating subassembly; the rotating subassembly comprises a wheel core and a clockwork spring, the wheel core is installed in the housing assembly and the retractable cable is wound on the wheel core and its connector extends out of the housing assembly, characterized in that the said the wireless charging module is directly installed on the wheel core and does not come into contact with the housing assembly so that it can rotate synchronously with the wheel core; the retractable cable passes through the wheel core and is electrically connected with the wireless charging module.

Further, the wheel core is provided with a holding groove and the wireless charging module is embedded in the holding groove to reduce the vertical space required for installing the wireless charging module and thus decrease the overall thickness of product; an avoidance opening is provided in the holding groove, and the retractable cable is electrically connected with the wireless charging module via the avoidance opening so that it is not necessary for the connecting wire (which can be the tail section of the retractable cable) to be wound outside the wheel core, such design makes the structure tidier and realizes synchronous rotation of the connecting wire with the wheel core and the wireless charging module, namely the relatively stationary state among them, and thus can realize more stable and reliable electrical connection and maintain the state for a long time.

Further, a shaft tube is provided in the center of the wheel core, a circle of outer-ring wall is installed on the periphery of the shaft tube, a threading opening is provided between the outer-ring wall and the shaft tube wherein the threading opening is connected with the avoidance opening; the connecting line of the retractable cable passes through the outer-ring wall and enters the threading opening and then is connected with the wireless charging module via the avoidance opening to realize the shortest connecting wire.

Further, a clockwork spring cavity is provided in the center of the bottom surface of the wheel core wherein the clockwork spring is embedded in the clockwork spring cavity and one end of the clockwork spring is connected and fixed with the wheel core and the clockwork spring does not protrude from the bottom surface of the wheel core.

Further, the said housing assembly comprises an upper housing and a lower housing wherein the said lower housing is provided with a stationary shaft and is installed on the stationary shaft via the shaft tube to realize the assembly of the wheel core; the lower part of the wheel core is located in the lower housing and the upper part of the wheel core and the wireless charging module are located in the upper housing and the other end of the clockwork spring is fixed on the stationary shaft; in the lower housing are provided with a plurality of sockets and on the bottom surface of the upper housing are provided with a plurality of pins, which are inserted into the sockets to fix the combination of the upper housing and the lower housing; therefore, such design is convenient for installation and requires no screws for fixing.

Further, the bottom surface of the wheel core forms a track plate, the bottom surface of the track plate is provided with a track groove for guiding the wheel core to rotate back and forth, and at least one edge position of the track groove is provided with a locating groove; in the lower housing is provided with a locating element and the said locating element is provided with a locating pin, and the said locating pin is inserted into the track groove and slides into the locating groove and thus stops the wheel core from moving when the locating pin slides in the track grove. The above structure for guidance and location via the track groove utilizes the technical solution to pull out and locate the existing retractable data cable.

Further, a wire groove is provided in the radial direction of the track plate and used to facilitate the assembly of the retractable cable, the width of the wire groove is smaller than the width of the locating element so that the retractable cable can pass through the wire groove when the retractable cable is assembled; therefore, such design facilitates the assembly of the retractable cable.

Further, a mounting groove is arranged in the lower housing, a mounting shaft is arranged in the mounting groove and the locating element is installed into a rotatable structure in the mounting groove via the mounting shaft.

Further, a protective sheathing is arranged in the opening on one side of the lower housing for the retractable cable to get in and out, the retractable cable is led out from the protective sheathing and the connector is located outside the protective sheathing. The protective sheathing can not only protect the cable from scratches but also help to ensure that the data cable stretches out and draws back smoothly.

Further, the wireless charging module is locked onto the wheel core via a top cover and a screw and the wheel core is movably installed on the stationary shaft of the lower housing via the top cover and the screw.

Further, a circle of magnet slot is arranged in the upper housing, a circle of magnet is installed in the magnet slot and the wireless charging module is encircled by the magnet; a cover is arranged on the wireless charging module and the cover is fixed on the upper housing to cover the wireless charging module and the magnet.

The present invention directly installs the wireless charging module on the wheel core so that it can rotate with the wheel core; such design eliminates the need to install the wireless charging module on the housing assembly and enables the wireless charging module to be embedded in the housing assembly and thus greatly reduces the overall thickness of product. In addition, such structure realizes a relatively stationary state between the retractable cable and the wireless charging module and further realizes direct electrical connection of the wireless charging module with the retractable cable and thus eliminate the need of circuit boards, connectors and other adapting structures. Therefore, the present not only simplifies the structure and reduces costs but also increases the stability of the electrical connection, makes it less prone to damage and has a longer service life. In addition, it can also help to reduce the product thickness, which is conducive to thinness. In addition, the present invention directly installs the clockwork spring in the wheel core and uses a narrow clockwork spring (such as for a single-pull cable structure) and integrates the track plate on the bottom surface of the wheel core to save the height space occupied by the clockwork spring and the track plate. Through the above-mentioned solution, the present invention can ensure that the overall thickness of product only accounts for about one half of the thickness of a conventional similar product; for example, the thickness of a conventional product is about 3 centimeters and the present invention can realize the product thickness falling in between 1.5 centimeters and 2 centimeters.

### BRIEF DESCRIPTION OF THE DRAWINGS

FIG. 1 is a three-dimensional structural view of the present invention;

FIG. 2 is a cutaway structural view of the present invention;

FIG. 3 is an exploded structural view of the present invention;

FIG. 4 is an exploded structural view from an alternative angle of the present invention;

FIG. 5 is a structural view of the present invention after the surface cover is removed;

FIG. 6 is a structural view of the present invention after the lower housing is removed;

FIG. 7 is a structural view when the wheel core couples the retractable cable;

FIG. 8 is a structural view of the wheel core.

In the above figures, 1-housing assembly; 11-lower housing; 12-upper housing; 13-stationary shaft; 14-socket; 15-magnet groove; 16-pin; 17-mounting groove; 18-mounting shaft; 2-wheel core; 21-holding groove; 22-avoidance opening; 23-outer-ring wall; 24-shaft tube; 25-threading opening; 26-track plate; 27-clockwork spring cavity; 28-track groove; 29-locating groove; 210-wire groove; 3-wireless charging module; 4-clockwork spring; 5-retractable cable; 51-connector; 52-connecting wire; 6-locating element; 61-locating pin; 71-top cover; 72-screw; 8-magnet; 9-surface cover; 10-protecting sheathing.

### DETAILED DESCRIPTION OF THE INVENTION

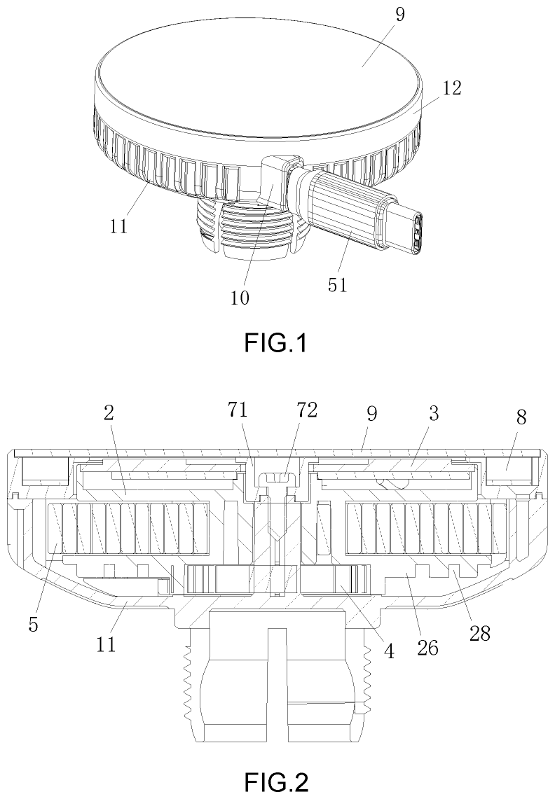

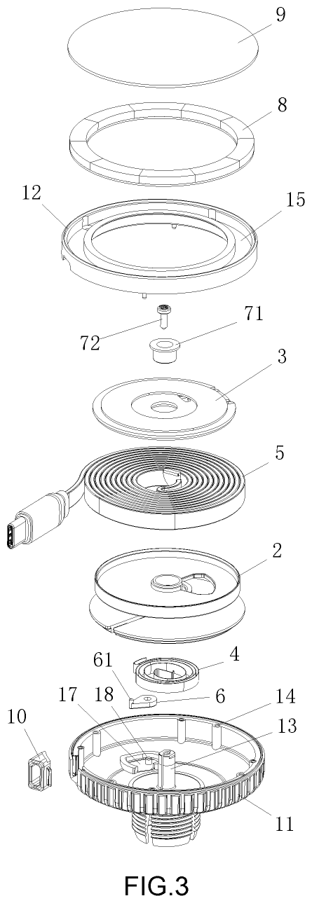

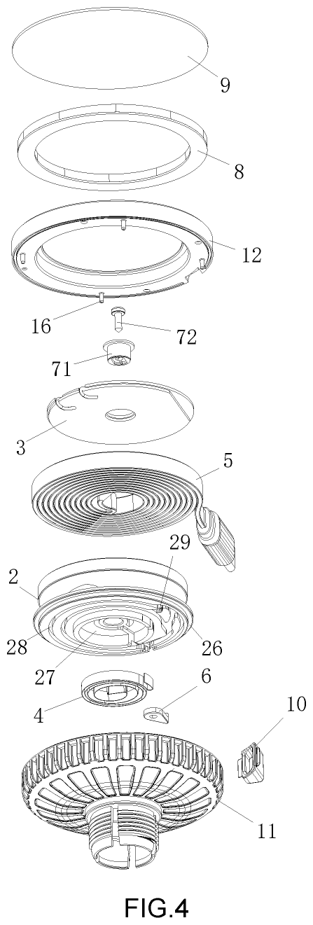

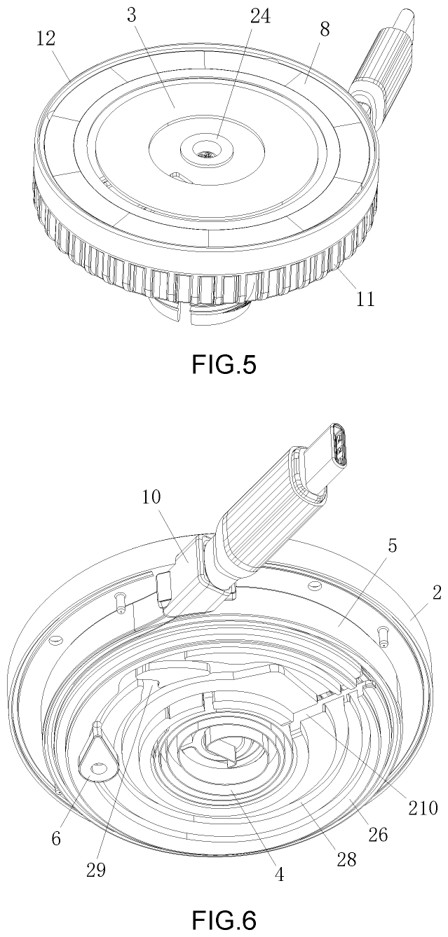

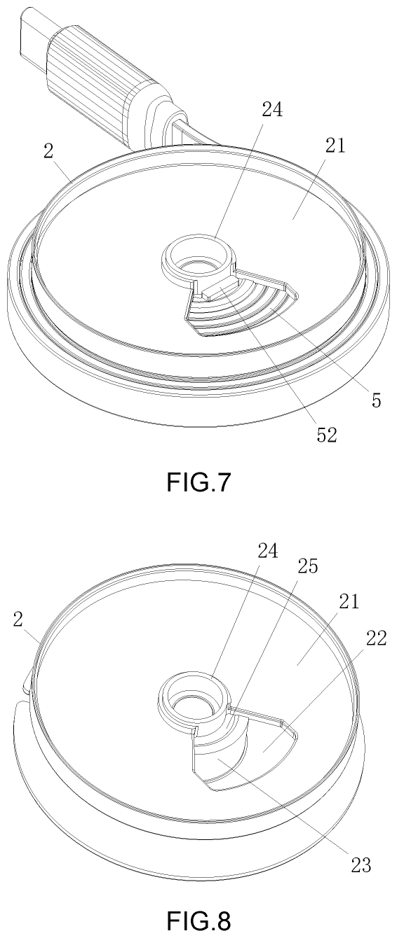

In the embodiment, from FIG. 1 to FIG. 8, the said lightweight wireless charging device with a retractable cable comprises a housing assembly, a wireless charging module (3), a retractable cable (5) and a rotating subassembly; the rotating subassembly comprises a wheel core (2) and a clockwork spring (4), the wheel core (2) is installed in the housing assembly and the retractable cable (5) is wound on the wheel core (20 and its connector (51) extends out of the housing assembly; the said the wireless charging module (3) is directly installed on the wheel core (2) and does not come into contact with the housing assembly so that it can rotate synchronously with the wheel core (2); the retractable cable (5) passes through the wheel core (2) and is electrically connected with the wireless charging module (3).

The wheel core (2) is provided with a holding groove (21) and the wireless charging module (3) is embedded in the holding groove (21) to reduce the vertical space required for installing the wireless charging module (3) and thus decrease the overall thickness of product; an avoidance opening (22) is provided in the holding groove (21), and the retractable cable (5) is electrically connected with the wireless charging module (3) via the avoidance opening (22) so that it is not necessary for the connecting wire (52) (which can be the tail section of the retractable cable) to be wound outside the wheel core (2), such design makes the structure tidier and realizes synchronous rotation of the connecting wire (52) with the wheel core (2) and the wireless charging module (3), namely the relatively stationary state among them; in this way, the connecting wire (52) will not intertwine with the wheel core (2) and can be directly connected via wires and thus can realize more stable and reliable electrical connection and maintain the state for a long time. For a single-pull cable structure, a section of the tail of the retractable cable (5) can be left as the connecting wire (52) for direct electrical connection with the wireless charging module (3), or the power cable can be led out from the wireless charging module (3) as the connecting wire for connection with the tail of the retractable cable; for a double-pull cable structure, the connecting wire (52) can be directly connected with the wireless charging module (3) from the position fixed on the wheel core (2) in the middle of the retractable cable (5), or the power cable can be led out from the wireless charging module (3) as the connecting wire for connection at the position fixed on the wheel core (2) in the middle of the retractable cable (5). Regardless of the structure, the connecting wire (52) can remain relatively stationary with the wheel core (2) and the wireless charging module (3).

A shaft tube (24) is provided in the center of the wheel core (2), a circle of outer-ring wall (23) is installed on the periphery of the shaft tube (24), a threading opening (25) is provided between the outer-ring wall (23) and the shaft tube (24) wherein the threading opening (25) is connected with the avoidance opening (22); the connecting wire (52) of the retractable cable (5) passes through the outer-ring wall (23) and enters the threading opening (25) and then is connected with the wireless charging module (3) via the avoidance opening (22) to realize the shortest connecting wire (52).

A clockwork spring cavity (27) is provided in the center of the bottom surface of the wheel core (2) wherein the clockwork spring (4) is embedded in the clockwork spring cavity (27) and one end of the clockwork spring is connected and fixed with the wheel core (2) and the clockwork spring (4) does not protrude from the bottom surface of the wheel core (2), in this way, the clockwork spring (4) does not occupy vertical space actually, meaning no increase in the product thickness due to the installation of the clockwork spring (4).

The said housing assembly comprises an upper housing (11) and a lower housing (12) wherein the said lower housing (12) is provided with a stationary shaft (13) and is installed on the stationary shaft (13) via the shaft tube (24) to realize the assembly of the wheel core (2) and enable the wheel core (2) to rotate along the stationary shaft (13); the lower part of the wheel core (2) is located in the lower housing (11) and the upper part of the wheel core (2) and the wireless charging module (3) are located in the upper housing (12) and the other end of the clockwork spring (4) is fixed on the stationary shaft (13); in the lower housing (11) are provided with a plurality of sockets (14) and on the bottom surface of the upper housing (12) are provided with a plurality of pins (16), which are inserted into the sockets (14) to fix the combination of the upper housing (12) and the lower housing (11); therefore, such design is convenient for installation and requires no screws for fixing.

The bottom surface of the wheel core (2) forms a track plate (26), the bottom surface of the track plate (26) is provided with a track groove (28) for guiding the wheel core (2) to rotate back and forth, and at least one edge position of the track groove (28) is provided with a locating groove (29); in the lower housing (11) is provided with a locating element (6) and the said locating element (6) is provided with a locating pin (61), and the said locating pin (61) is inserted into the track groove (28) and slides into the locating groove (29) and thus stops the wheel core (2) from moving when the locating pin (61) slides in the track grove (28). Only further stretching the retractable cable (5) enables the locating pin (61) to enter the track groove (28) from the locating groove (29); at the moment, releasing the retractable cable (5) enables the retractable cable (5) to rotate with the wheel core (2) and enter the housing assembly under the resilient force of the clockwork spring (4).

A wire groove (210) is provided in the radial direction of the track plate (26) and used to facilitate the assembly of the retractable cable (5), the width of the wire groove (210) is smaller than the width of the locating element (6) so that the retractable cable (5) can pass through the wire groove (210) when the retractable cable (5) is assembled; therefore, such design facilitates the assembly of the retractable cable (5). The wire groove (210) will cut off the track groove (28); however, the width of the wire groove (210) is smaller than the width of the locating element (6); therefore, when the wheel core (2) rotates, the locating element (6) will cross the wire groove (210) and not fall into the wire groove (210), ensuring that the existence of the wire groove (210) does not affect the sliding of the locating pin (61) in the track groove (28).

A mounting groove (17) is arranged in the lower housing (11), a mounting shaft (18) is arranged in the mounting groove (17) and the locating element (6) is installed into a rotatable structure in the mounting groove (17) via the mounting shaft (18).

A protective sheathing (11) is arranged in the opening on one side of the lower housing (11) for the retractable cable (5) to get in and out, the retractable cable (5) is led out from the protective sheathing (10) and the connector (51) is located outside the protective sheathing (10). The protective sheathing (10) can not only protect the cable from scratches but also help to ensure that the data cable stretches out and draws back smoothly.

The wireless charging module (3) is locked onto the wheel core via a top cover (71) and a screw (72) and the wheel core (2) is movably installed on the stationary shaft (13) of the lower housing (11) via the top cover (71) and the screw (72).

A circle of magnet groove (15) is arranged in the upper housing (12), a circle of magnet (8) is installed in the magnet groove (15) and the wireless charging module (3) is encircled by the magnet (8); a surface cover (9) is arranged on the wireless charging module (3) and the surface cover (9) is fixed on the upper housing (12) to cover the wireless charging module (3) and the magnet (8).

The present invention has been described in detail; the described embodiments are merely the preferred embodiments of the present invention and cannot be understood to limit the embodiment scope of the present invention; equivalent changes and modifications made within the scope of the present application should belong to the scope covered by the present invention.

What is claimed is:

1. A lightweight wireless charging device with a retractable cable, comprising a housing assembly, a wireless charging module, a retractable cable and a rotating subassembly; the rotating subassembly comprises a wheel core and a clockwork spring, the wheel core is installed in the housing assembly and the retractable cable is wound on the wheel core and its connector extends out of the housing assembly, characterized in that the said the wireless charging module is directly installed on the wheel core and does not come into contact with the housing assembly so that it can rotate synchronously with the wheel core; the retractable cable passes through the wheel core and is electrically connected with the wireless charging module.

2. The lightweight wireless charging device with a retractable cable in accordance with claim 1, characterized in that the wheel core is provided with a holding groove and the wireless charging module is embedded in the holding groove; an avoidance opening is provided in the holding groove, and the retractable cable is electrically connected with the wireless charging module via the avoidance opening.

3. The lightweight wireless charging device with a retractable cable in accordance with claim 2, characterized in that a shaft tube is provided in the center of the wheel core, a circle of outer-ring wall is installed on the periphery of the shaft tube, a threading opening is provided between the outer-ring wall and the shaft tube wherein the threading opening is connected with the avoidance opening; the connecting wire of the retractable cable passes through the outer-ring wall and enters the threading opening and then is connected with the wireless charging module via the avoidance opening.

4. The lightweight wireless charging device with a retractable cable in accordance with claim 3, characterized in that a clockwork spring cavity is provided in the center of the bottom surface of the wheel core wherein the clockwork spring is embedded in the clockwork spring cavity and one end of the clockwork spring is connected and fixed with the wheel core and the clockwork spring does not protrude from the bottom surface of the wheel core.

5. The lightweight wireless charging device with a retractable cable in accordance with claim 4, characterized in that the said housing assembly comprises an upper housing and a lower housing wherein the said lower housing is provided with a stationary shaft and is installed on the stationary shaft via the shaft tube to realize the assembly of the wheel core; the lower part of the wheel core is located in the lower housing and the upper part of the wheel core and the wireless charging module are located in the upper housing and the other end of the clockwork spring is fixed on the stationary shaft; in the lower housing are provided with a plurality of sockets and on the bottom surface of the upper housing are provided with a plurality of pins, which are inserted into the sockets to fix the combination of the upper housing and the lower housing.

6. The lightweight wireless charging device with a retractable cable in accordance with claim 5, characterized in that the bottom surface of the wheel core forms a track plate, the bottom surface of the track plate is provided with a track groove for guiding the wheel core to rotate back and forth, and at least one edge position of the track groove is provided with a locating groove; in the lower housing is provided with a locating element and the said locating element is provided with a locating pin, and the said locating pin is inserted into the track groove and slides into the locating groove and thus stops the wheel core from moving when the locating pin slides in the track grove.

7. The lightweight wireless charging device with a retractable cable in accordance with claim 6, characterized in that a wire groove is provided in the radial direction of the track plate and used to facilitate the assembly of the retractable cable.

8. The lightweight wireless charging device with a retractable cable in accordance with claim 6, characterized in that a mounting groove is arranged in the lower housing, a mounting shaft is arranged in the mounting groove and the locating element is installed into a rotatable structure in the mounting groove via the mounting shaft.

9. The lightweight wireless charging device with a retractable cable in accordance with claim 4, characterized in that a protective sheathing is arranged in the opening on one side of the lower housing for the retractable cable to get in and out, the retractable cable is led out from the protective sheathing and the connector is located outside the protective sheathing.

10. The lightweight wireless charging device with a retractable cable in accordance with claim 5, characterized in that the wireless charging module is locked onto the wheel core via a top cover and a screw and the wheel core is movably installed on the stationary shaft of the lower housing via the top cover and the screw.

11. The lightweight wireless charging device with a retractable cable in accordance with claim 5, characterized in that a circle of magnet groove is arranged in the upper housing, a circle of magnet is installed in the magnet groove and the wireless charging module is encircled by the magnet; a surface cover is arranged on the wireless charging module and the surface cover is fixed on the upper housing to cover the wireless charging module and the magnet.
